(19) United States
(12) Patent Application Publication
(10) Pub. No.: US 2008/0197213 A1
(43) Pub. Date: Aug. 21, 2008

(54) ACTIVE MATERIAL DIFFUSER AND METHOD OF PROVIDING AND USING SAME

(76) Inventors: Stanley J. Flashinski, Racine, WI (US); Ranjit A. De Silva, Racine, WI (US); William G. Parsons, Racine, WI (US); Allen D. Miller, Racine, WI (US); Scott W. Schermer, Pewaukee, WI (US); Gene Sipinski, Elgin, IL (US)

Correspondence Address: S.C. JOHNSON & SON, INC., 1525 HOWE STREET, RACINE, WI, 53403-2236, US

(21) Appl. No.: 11/676,701

(22) Filed: Feb. 20, 2007

(51) Int. Cl. B05B 1/00

(52) U.S. Cl. 239/288.5

(57) ABSTRACT

An active material diffuser includes a container and a device for emitting an active material, wherein the device is adapted to be disposed within the container during use of the device. The diffuser further includes a cover disposed atop the container and enclosing the device within the container when the device is not in use.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to diffusion devices and, more particularly, to devices for diffusing active materials.

2. Description of the Background of the Invention

A multitude of active material diffusion devices or diffusers exist in the marketplace. Many of such devices are passive devices that require only ambient air flow to disperse a liquid active material therein. Other devices are battery-powered or receive power via a plug. A cord may be coupled between the plug and the device, or the plug may be mounted directly on the device.

Various means for dispensing active materials from diffusion devices are also known in the art. For example, some diffusion devices include a heating element or other heat source for heating an active material to promote vaporization thereof. Other diffusion devices employ a fan to generate air flow to direct active material out of the diffusion device into the surrounding environment. In another type of diffusion device, active material may be emitted from the device using a bolus generator that develops a pulse of air to eject a ring of active material. Still other diffusion devices utilize an ultrasonic transducer to break up an active material into droplets that are ejected from the device.

Vibratory-type liquid atomization devices are described in Helf et al. U.S. Pat. No. 6,293,474, Martin et al. U.S. Pat. No. 6,341,732, Tomkins et al. U.S. Pat. No. 6,382,522, Martens, III et al. U.S. Pat. No. 6,450,419, Helf et al. U.S. Pat. No. 6,706,988, and Boticki et al. U.S. Pat. No. 6,843,430, all of which are assigned to the assignee of the present application and which are hereby incorporated by reference herein. These patents disclose devices comprising a piezoelectric actuating element coupled to a liquid atomization plate. The piezoelectric actuating element vibrates the liquid atomization plate in response to alternating electrical voltages applied to the actuating element. The vibration of the plate causes atomization of a liquid supplied by a liquid delivery system. An electrical circuit is provided to supply the alternating electrical voltages to conductive elements that are in electrical contact with opposite sides of the actuating element. The conductive elements may also serve to support the actuating element and the liquid atomization plate in a housing that contains the device.

Various light-emitting devices that emulate a candle are also known in the art. One such device includes a cylindrical body having a light-emitting diode (LED) disposed within the cylindrical body to emulate a pillar candle. The device includes a switching element that is activated and deactivated to turn the LED on and off. A timer is started once the LED is turned on, wherein the timer is set to turn off the LED after a predetermined period of time. Other light-emitting devices are made of a wax or wax-like material. Others implement a flicker program to cause the LED to flicker as a real candle would flicker.

### SUMMARY OF THE INVENTION

According to one aspect of the present invention, an active material diffuser includes a container and a device for emitting an active material, wherein the device is adapted to be disposed within the container during use of the device. The diffuser further includes a cover disposed atop the container and enclosing the device within the container when the device is not in use.

According to another aspect of the present invention, an active material diffuser includes a container having an opening and a device for emitting an active material, wherein the device is disposed within the opening of the container. The diffuser further includes a flexible cover removably attached to the container to close the opening and enclose the device within the container, wherein pressure exerted on a portion of the cover is transferred to the device to actuate the device.

According to a further aspect of the present invention, a method of providing an active material diffuser includes the step of providing a container, a device for emitting an active material, and a cover for the container. The method further includes the step of directing a user to actuate the device by pressing downwardly on the cover when the device is disposed within the container and the cover is removably attached to the container.

According to still another aspect of the present invention, a method of using an active material diffuser includes the step of positioning a device within a container, wherein the device emits active material. The method further includes the steps of placing a cover atop the container to enclose the device within the container and exerting pressure on the cover to actuate the device.

Other aspects and advantages of the present invention will become apparent upon consideration of the following detailed description and the attached drawings, in which like elements are assigned like reference numerals.

### BRIEF DESCRIPTION OF THE DRAWINGS

FIG. 1 is a top isometric view of a light and active material emitting device;

FIG. 2 is a top isometric view of the device of FIG. 1;

FIG. 3 is a top isometric view illustrating the device of FIG. 1 with a cover portion removed therefrom;

FIG. 4 is an exploded view of the device of FIG. 1 with a cover portion and a housing cover removed therefrom;

FIG. 5 is a is a top isometric view illustrating a housing cover as depicted in the device of FIG. 1;

FIG. 6 is a cross-sectional view taken generally along the lines 6-6 of FIG. 1;

FIG. 6A is a top trimetric view of a reservoir containing active material for insertion into the device of FIG. 1;

FIG. 7 is a top isometric view illustrating electronics of the device of FIG. 1;

FIG. 8 is a is a bottom plan view illustrating the device of FIG. 1;

FIG. 9 is a cross-sectional view taken generally along the lines 9-9 illustrating a cover portion of the device of FIG. 1;

FIG. 10 is an isometric view illustrating the device of FIG. 1 disposed within a container;

FIG. 11 is a cross-sectional view taken generally along the lines 11-11 of FIG. 10;

FIG. 12 is a side elevational view of a cover for the container of FIG. 10;

FIG. 13 is a cross-sectional view taken generally along the lines 13-13 of FIG. 12;

FIG. 14 is a bottom elevational view of the cover of FIG. 12;

FIG. 15 is a bottom trimetric view of the cover of FIG. 12;

FIG. 16 is a cross-sectional view similar to that of FIG. 11 with the cover of FIG. 12 disposed atop the container; and

FIG. 17 is a cross-section view similar to that of FIG. 11 with the cover of FIG. 12 disposed beneath the container.

Throughout the FIGS., like or corresponding reference numerals have been used for like or corresponding parts.

### DETAILED DESCRIPTION

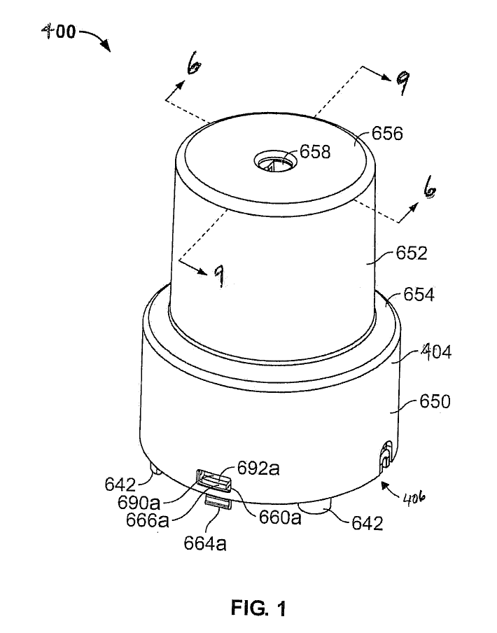

An embodiment of a light and active material emitting device 400 is illustrated in FIGS. 1-9. Referring to FIGS. 1, 2, and 4, the device 400 generally includes a cover portion 404 and a base portion 406. The base portion 406 generally includes a base 408 and a housing 410 disposed on the base 408 for enclosing control circuitry (described hereinafter) for the device 400. A column 412 extends upwardly from the housing 410 and is preferably integral with the housing 410. Further, an arm portion 414 extends perpendicularly from the column 412 and is integral with the column 412. The arm portion 414 includes an active material dispenser in the form of an atomizer assembly 416 that extends through a center portion 418 thereof.

Any of the atomizer assemblies of Helf et al. U.S. Pat. No. 6,293,474, Denen et al. U.S. Pat. No. 6,296,196, Martin et al. U.S. Pat. No. 6,341,732, Tomkins et al. U.S. Pat. No. 6,382,522, Martens, III et al. U.S. Pat. No. 6,450,419, Helf et al. U.S. Pat. No. 6,706,988, Boticki et al. U.S. Pat. No. 6,843,430, and Helf et al. U.S. Pat. No. 6,896,193, all of which are assigned to the assignee of the present application and which are hereby incorporated by reference herein, may be utilized as the atomizer assembly 416. In general, these assemblies apply an alternating voltage to a piezoelectric element to cause the element to expand and contract. The piezoelectric element is coupled to a perforated orifice plate 419, which in turn is in surface tension contact with a liquid source. The expansion and contraction of the piezoelectric element causes the orifice plate to vibrate up and down whereupon liquid is driven through the perforations in the orifice plate and is then emitted upwardly in the form of aerosolized particles.

Preferably, a reservoir 420 having an active material therein is inserted into the active material dispenser adjacent the atomizer assembly 416 for emission of the active material therefrom. The active material is preferably a liquid material and may include one or more of fragrances, disinfectants, sanitizers, insect control active ingredients (including but not limited to insecticides, insect repellants, insect attractants, and other active ingredients that kill or modify the behavior or development of insects, “insects” being defined herein as actual insects together with other arthropods commonly controlled by like means) medicaments, air purifiers, aromatherapy scents, antiseptics, odor eliminators, air-fresheners, deodorizers, and such other active ingredients that are usefully dispersed into the air.

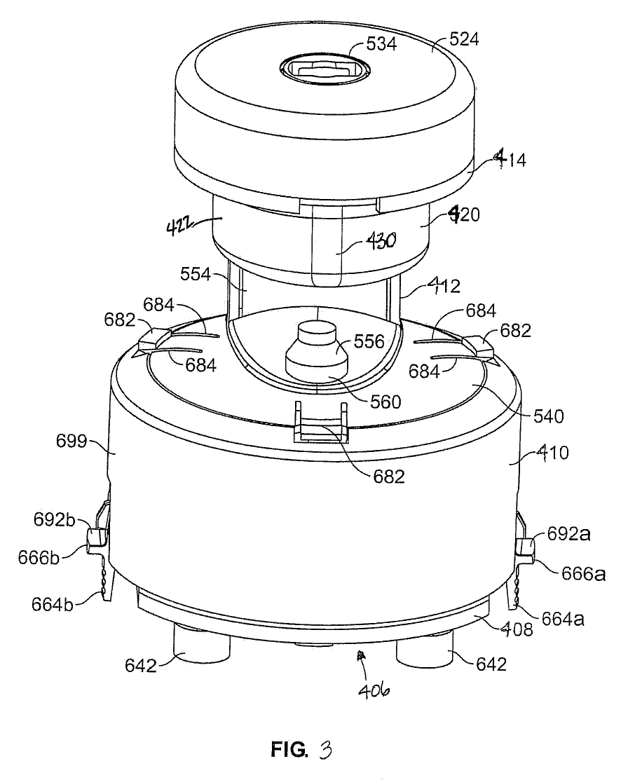

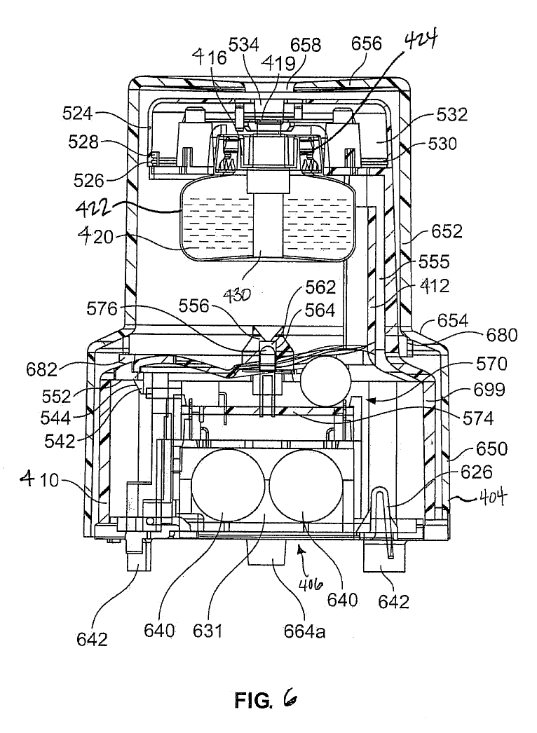

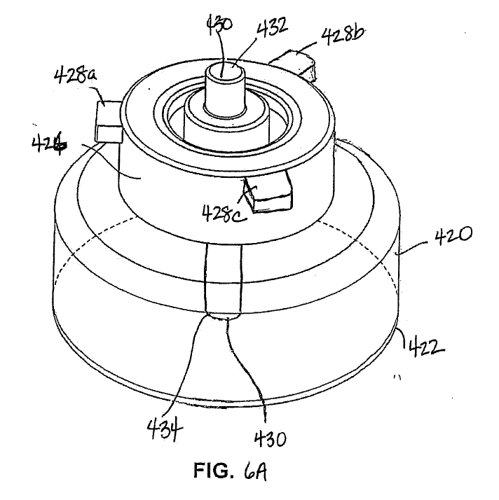

As shown in FIGS. 3, 4, 6, and 6A, the reservoir 420 comprises a transparent cylindrical container 422 with a neck 424 (seen in FIG. 6A). Referring to FIG. 6A, a combination plug and wick holder 426 is affixed to the neck 424, wherein the plug and wick holder 426 includes three equally-spaced laterally extending mounting lugs 428a-428c. A wick 430 is disposed within the reservoir 422 in contact with fluid therein. An upper end 432 of the wick 432 extends beyond the neck 424 and a lower end 434 of the wick 430 is disposed within the reservoir 420 toward a bottom surface 440 thereof. The wick 430 transfers liquid by capillary action from within the reservoir 420 to the upper end 432 of the wick 430. The fluid reservoir 420 is inserted into the arm portion of 414 by aligning the lugs 428a-428c with corresponding bayonet slots (not shown) in the arm portion 414 and pushing the reservoir 420 upwardly, thereby inserting the lugs 428a-428c into the respective bayonet slots. The reservoir 420 is thereafter rotated to force the lugs 428a-428c to engage with the walls defining the detent portions of the respective bayonet slots to secure the reservoir 420 within the device 400. If desired, the lugs 428a-428c and respective and respective bayonet slots may be unequally spaced or any number of lugs 428a-428c and bayonet slots may be employed.

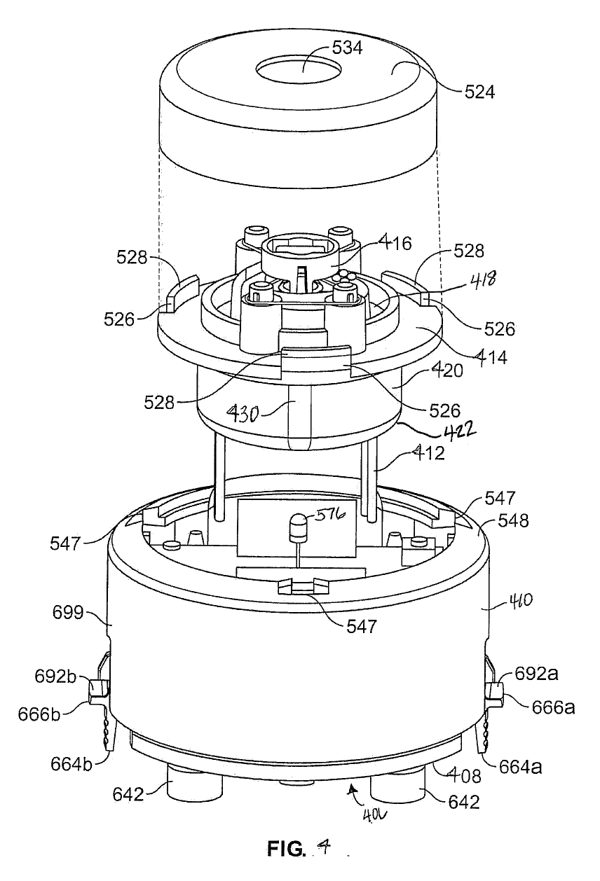

A cap 524, as best seen in FIGS. 3 and 4, may be disposed over the atomizer assembly 416 to hide the components of the atomizer assembly 416. Preferably, as seen in FIGS. 4 and 6, the arm portion 414 includes a plurality of upwardly extending projections 526 extending therefrom, wherein outwardly extending projections 528 extend from the upwardly extending projections 526. The outwardly extending projections 528 are adapted to engage an annular lip 530 extending from an inner periphery 532 of the cap 524 to secure the cap 524 over the atomizer assembly 416. The cap 524 further includes a central circular aperture 534 therein such that active material emitted from the atomizer assembly 416 is directed through the aperture 534.

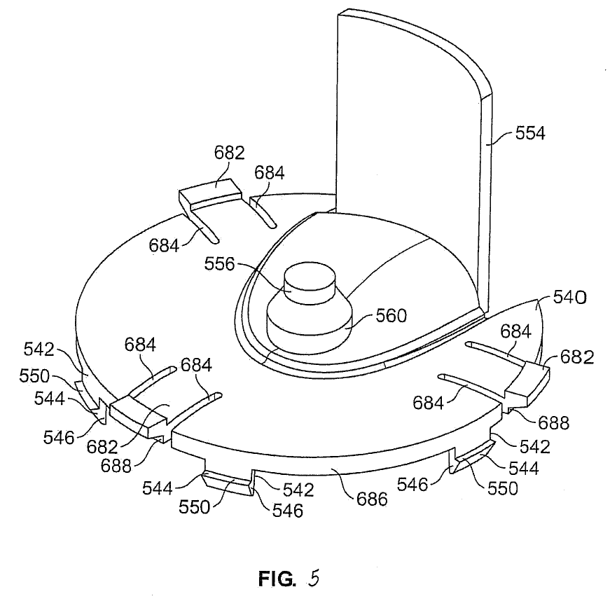

Referring to FIGS. 3 and 5, the base portion 406 further includes a housing cover 540 disposed atop the housing 410. As seen in FIG. 5, the housing cover 540 includes a plurality of downwardly extending projections 542, wherein an outwardly extending projection 544 extends from a bottom portion 546 of each downwardly extending projection 542. The housing 410 includes a plurality of cutout portions 547 in a top portion 548 thereof, wherein the downwardly extending projections 542 extend into the cutout portions 547 such that top portions 550 of the outwardly extending projections 544 engage an inner upper surface 552 (FIG. 6) of the housing 410 to retain the housing cover 540 on the housing 410.

As best seen in FIG. 5, the housing cover 540 further includes an upwardly extending column 554 that interfits with the column 412 extending from the housing 410 when the housing cover 540 is disposed on the housing 410 to form a channel 555. Preferably, wires extending from the electrical components of the control circuitry to the atomizer assembly 416 are disposed in the channel 555 to hide and protect the wires. Also preferably, the columns 412, 554 are formed of a transparent or translucent material, preferably a clarified material, such as clarified propylene, so that the columns 412, 554 allow light to pass therethrough. Still further, the housing cover 540 includes a light control device 556, such as a light diffuser, light pipe, lens, or the like, in a center portion 560 thereof, wherein the light control device 556 is preferably secured to or integral with the housing cover 540. The light control device 556 generally includes a cavity 562 in a bottom portion 564 thereof, as best seen in FIG. 6. Various embodiments of light control devices 556 will be discussed in greater detail hereinafter.

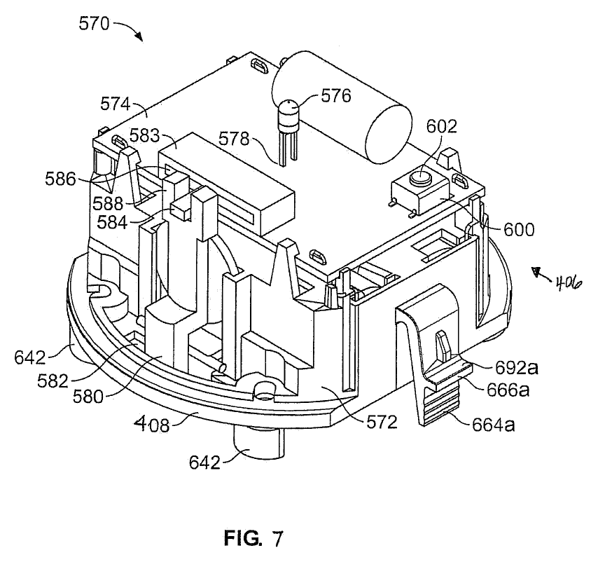

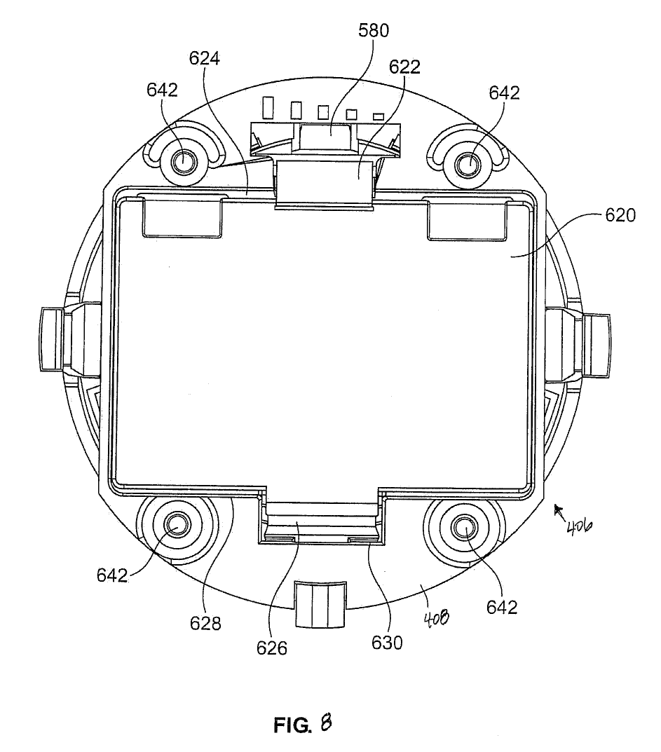

As seen in FIG. 6, the base portion 406 of the device encloses control circuitry shown at 570. In particular, the base 408 includes a support structure 572 extending upwardly therefrom that supports a printed circuit board (PCB) 574. An LED 576 is operatively connected to and extends upwardly from a central portion 578 of the PCB 574. As best seen in FIGS. 7 and 8, an optional emission frequency actuator arm 580 extends through a rectangular aperture 582 in a bottom portion of the base 408. The emission frequency actuator arm 580, if present, is operatively connected to a slide switch 583, wherein the slide switch 583 is operatively connected to the PCB 574. The actuator arm 580 includes five selectable positions that control the emission frequency of the atomizer assembly 416. Optionally, the actuator arm 580 may instead be movable between two selectable positions, wherein when the actuator arm 580 is disposed on a first position the device 400 is turned on and when the actuator arm 580 is disposed in a second position the device 400 is turned off. Still further, the actuator arm 580 may instead be moveable between any number of selectable positions. The slide switch 583 includes a button 584 extending therefrom that is movable along a slot 586 in the slide switch 583 to one of five detent positions. A yoke 588 extending from the actuator arm 580 surrounds the button 584 on sides thereof to move the button 584 along the slot 586. Selection of a position by the user with respect to the actuator arm 580 moves the button 584 within the slot 586, thereby indicating to the slide switch 583 the current position of the actuator arm 580. The positions of the slide switch 583 are detected by the PCB 574. Components mounted on the PCB 574 control the atomizer assembly 416 corresponding to the position of the actuator arm 580, wherein each of the positions correspond to different time intervals that define the dwell time or the time between subsequent emission of puffs of active material by the atomizer assembly 416. In one embodiment in which the actuator arm 580 includes five selectable positions, the positions may correspond to dwell times of 250 milliseconds, 335 milliseconds, 425 milliseconds, 500 milliseconds, and off (no emission of active material). Such dwell times are effective in continually keeping an area filled with the active material, which increases the efficacy of some active materials, such as insect control active ingredients. As discussed above, wires extend from the PCB 574 to the atomizer assembly 416 to actuate the atomizer assembly 416 in dependence upon the position of the actuator arm 580.

The PCB 574 further includes a switch 600 having a depressable button 602 extending upwardly therefrom. Depression of the button 602 turns the LED 576 on or off depending on the current state of the LED 576. Optionally, depression of the button 602 may also toggle the atomizer assembly 416 between on and off states. The actuation of the button 602 and the operation of the control circuitry 570 will be discussed in greater detail hereinafter.

As noted above, the housing 410 encloses the PCB 574 and other control circuitry and the LED 576. When the housing cover 540 is attached to the housing 410, as discussed in detail above, the LED 576 is disposed in the cavity 562 located at the bottom portion 564 of the light control device 556, such that light emitted from the LED 576 may be reflected and refracted by the light control device 556.

Referring to FIG. 8, the base portion 406 of the device 400 includes a battery door 620 that includes a hinge 622 at a first end 624 thereof and a latching mechanism 626 at a second end 628 thereof. The latching mechanism 626 interacts with a locking recess 630 in the base portion 406 to hold the battery door 620 in a closed position. The latching mechanism 626 may be flexed to release the latching mechanism 626 from the locking recess 630, such that the battery door 620 may pivot about the hinge 622 to open the battery door 620 and allow access to a battery compartment 631.

As further seen in FIG. 6, the base portion 406 of the device 400 includes two batteries 640 that preferably provide direct current that is converted into high-frequency alternating current power that is selectively applied to the atomizer assembly 406 and the LED 576. Optionally, the device 400 may be powered by alternating household current, which is rectified, converted to high-frequency alternating current power, and reduced in voltage and applied intermittently to the atomizer assembly 416 and/or the LED 576. The batteries 640 may be any conventional dry-cell battery such as “A”, “AA”, “AAA”, “C”, and “D” cells, button cells, watch batteries, and solar cells, but preferably, the batteries 640 are “AA” or “AAA” cell batteries. Although two batteries are preferred, any number of batteries that would suitably fit within the device 400 and provide adequate power level and service life may be utilized.

The base portion 406 may further include optional feet 642 extending therefrom to aid in stabilizing the active material emitting device 400. Although four feet 642 are depicted, any suitable number of feet 642 for stabilizing the device 400 may be utilized.

Referring to FIG. 9, the cover portion 404 includes a lower cylindrical wall 650 having a first diameter and an upper cylindrical wall 652 having a second diameter that is preferably smaller than the first diameter. An angled wall 654 joins the lower cylindrical wall 650 to the upper cylindrical wall 652. The cover portion 404 further includes a circular top wall 656 adjacent the upper cylindrical wall 652 and having a circular aperture 658 disposed in a central portion thereof.

As seen in FIG. 6, the cover portion 404 is positioned over the base portion 406 during use of the device 400. Specifically, the cover portion 404, as detailed in FIG. 9, includes first and second apertures 660a, 660b disposed opposite one another in a periphery 662 of the lower cylindrical wall 650. The base portion 406 includes first and second spring clips 664a, 664b, as seen in FIG. 3, extending from opposing sides of the housing 410. Each of the spring clips 664a, 664b includes a protrusion 666a, 666b, respectively, extending outwardly therefrom. In use, the cover portion 404 is placed over the base portion 406 such that the upper cylindrical wall 652 surrounds the column 412, the arm portion 414, and the atomizer assembly 416, and the lower cylindrical wall 650 abuts an outer wall 668 of the housing 410. The cover portion 404 is further positioned over the base portion 406 such that the atomizer assembly 416 is aligned with the aperture 658 in the top wall 656 of the cover portion 404. The aperture 658 provides an outlet for active material that is atomized by the atomizer assembly 416 and emitted from the device 400. As the cover portion 404 is placed over the base portion 406, the spring clips 664a, 664b are pressed inwardly by the user. Once the apertures 660a, 660b in the lower cylindrical wall 650 are aligned with the protrusions 666a, 666b extending from the spring clips 664a, 664b, the user may release the spring clips 664a, 664b. As the spring clips 664a, 664b are released, the protrusions 666a, 666b move outwardly into the apertures 660a, 660b. Walls 670a, 670b defining each of the protrusions 666a, 666b, respectively, thereby interfere with walls 672a, 672b defining the respective aperture 660a, 660b to prevent removal of the cover portion 404 from the base portion 406. If the user desires to remove the cover portion 404, the user may press inwardly on the spring clips 664a, 664b and remove the cover portion 404.

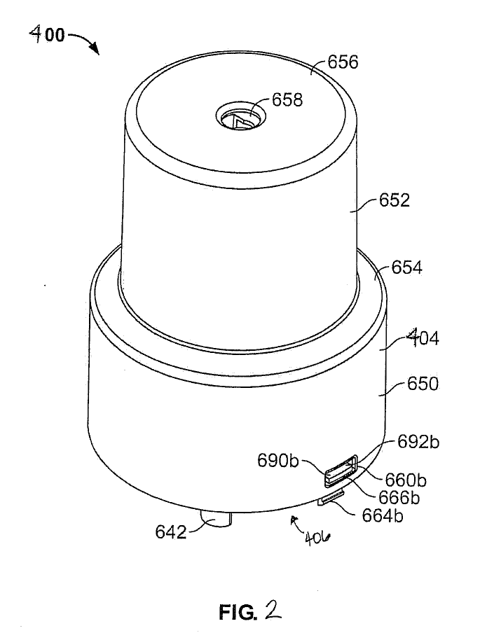

As best seen in FIG. 9, the cover portion 404 further includes an annular ring 680 extending downwardly from an intersection of the upper cylindrical wall 652 and the angled connecting wall 654 of the cover portion 404. As seen in FIG. 5, the housing cover 540 includes a plurality of spring fingers 682 in part defined by slots 684 that extend inwardly from a periphery 686 of the housing cover 540. Each of the spring fingers 682 includes a projection 688, as best seen in FIG. 5, extending downwardly therefrom. The annular ring 680 rides on top of the spring fingers 682, which are resilient and act as flexures biased upwardly. Thus, as seen in FIGS. 1 and 2, the cover portion 404 is biased in a position such that upper surfaces 692a, 692b of the protrusions 666a, 666b are spaced from upper walls 694a, 694b of the apertures 660a, 660b to create gaps 690a, 690b therebetween. The gaps 690a, 690b allow movement of the cover portion 404 in a vertical direction relative to the housing 410. A user may therefore exert downward pressure on the cover portion 404 against the bias of the resilient spring fingers 682 that act as flexures. Such pressure allows the cover portion 404 to move downwardly until the upper surfaces 692a, 692b of the protrusions 666a, 666b of the spring clips 664a, 664b abut the upper walls 694a, 694b respectively, of the apertures 660a, 660b. As the cover portion 404 moves downwardly, the annular ring 680 flexes the spring fingers 682 downwardly. As the spring fingers 682 move downwardly, one of the projections 688 extending downwardly from the spring fingers 682 that is aligned with the depressable button 602 contacts the depressable button 602, thereby activating the switch 600. A change in state of the switch 600 is detected by the PCB 574 and the LED 576 and/or the atomizer assembly 416 are turned on (for a predetermined timeframe) or off depending on the current state of the LED 576 and/or the atomizer assembly 416, as described in greater detail hereinafter.

The cover portion 404 is preferably made of a transparent or translucent material, such as glass and/or a polymeric resin, such that the cover portion 404 functions as a light diffuser. All or portions of an inner surface 696 and/or an outer surface 698 of the cover portion 404 may include a surface treatment, such as a frosted surface, a coating, a roughened surface, a textured surface, and/or the like, in order to provide an even dispersion of light through the cover portion 404. Optionally, one or more of a lower portion 699 (FIG. 6) of the housing 410 or the lower cylindrical wall 650 of the cover portion 404 may include a decal or other obscuring element thereon in order to prevent the electronics of the device 400 from being viewed from outside the device 400. Still optionally, a decal or other obscuring element may be positioned on the upper cylindrical wall 652 of the cover portion 404.

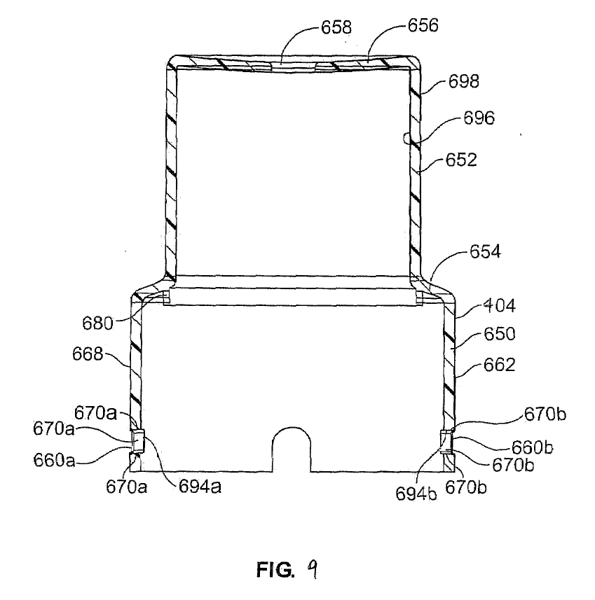

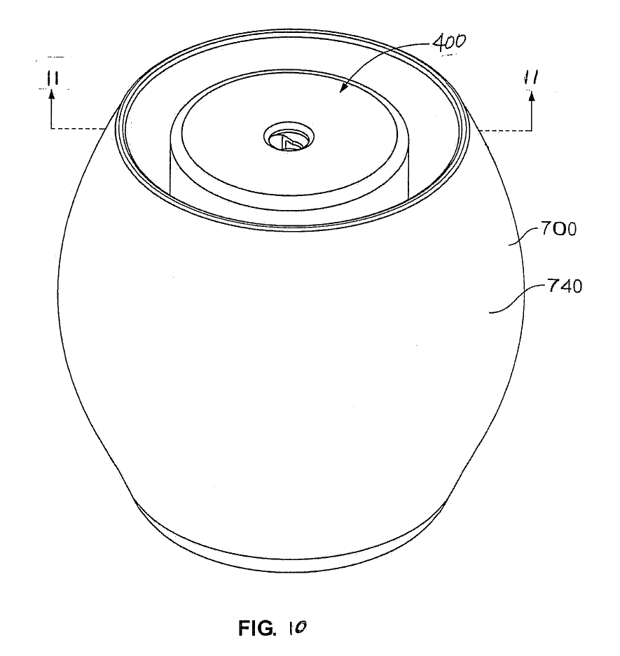

As seen in FIGS. 10 and 11, the active material emitting device 400 may be placed into a container 700 for use thereof, or may be placed on a surface and used alone. The container 700 also preferably acts as a light diffuser and may be made of a transparent or translucent material, such as glass and/or a polymeric resin. All or portions of an inner surface 702 and/or an outer surface 704 of the container may include a surface treatment, such as a frosted surface, a coating, a roughened surface, a textured surface, and the like, to provide relatively even dispersion of light through the container 700. Optionally, one or more images may be formed on the container 700 by placing a sticker 705 or other image-forming device (such as a decal) on a surface thereof. Still optionally, etchings may be formed in the light control device 556 to project a shape or shadow, as desired.

Although one shape of container is depicted herein, any shape of container is contemplated, as long as the device 400 fits sufficiently therein.

Referring to FIG. 11, the active material emitting device 400 is disposed within the container 700 such that the feet 642 of the device 400 rest upon an upper surface 706 of a bottom portion 708 of the container 700. Preferably, the device 400 fits within the container 700 without portions of the lower or upper cylindrical walls 650, 652 touching the inner surface 702 of the container 700. As further seen in FIG. 11, the top wall 656 of the housing cover 540 may be aligned with an annular rim 720 disposed at a top portion 722 of the container 700. Optionally, the top wall 656 of the housing cover 540 may be disposed below or above the annular rim 720.

Any light emitted upwardly from the LED 576 along a longitudinal axis 730 of the device 400 is blocked from exiting the device 400 by the atomizer assembly 416 and reservoir 420 due to the positioning of such components above the LED 576. The light control device 556 that is disposed above and around the LED 576 is provided to reflect and/or refract light that is emitted from the LED 576. Most of the light that is emitted upwardly along the longitudinal axis 730 is reflected and/or refracted by the light control device 556 and emitted from the device 400 radially outwardly through a central portion thereof. As seen in FIG. 10, this positions the light around a center portion 740 of the container 700 and device 400, instead of near a top portion 742 thereof.

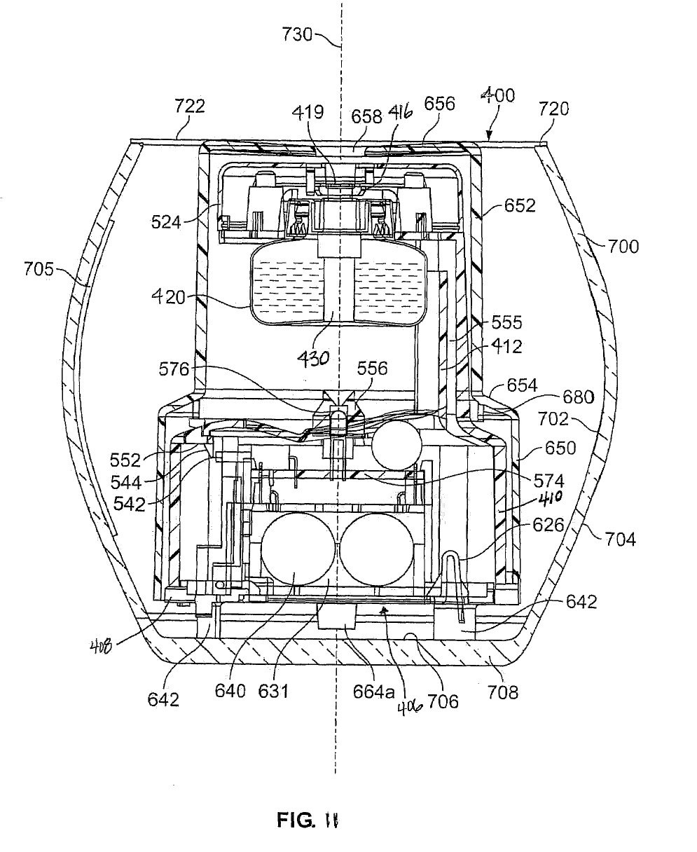

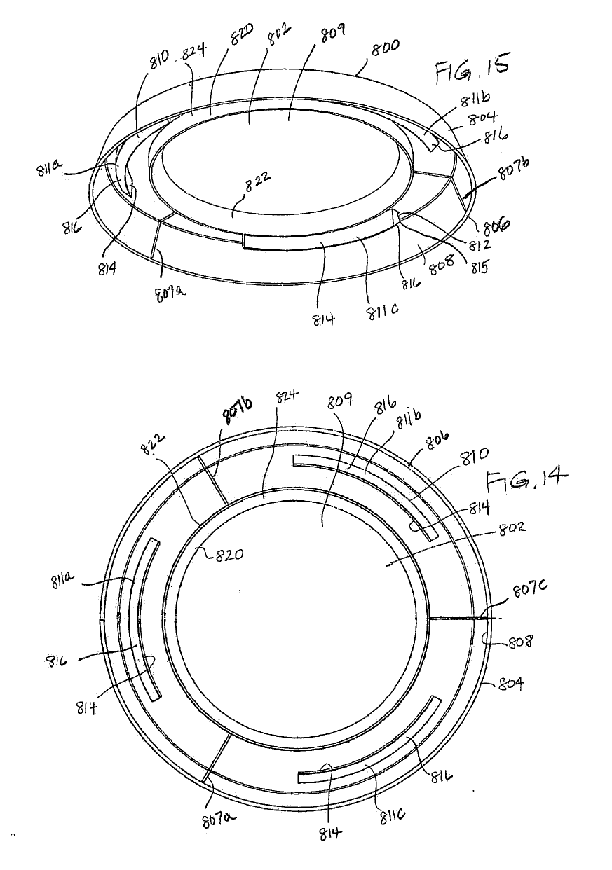

A cover 800 for the container 700 is depicted in FIGS. 12-17. As seen in FIG. 12, the cover 800 includes an upper wall 802 having a first diameter D1 and a first annular flange 804 extending downwardly and outwardly from the upper wall 802. The first annular flange 804 has a lower extent 806 having a second diameter D2 that is preferably greater than the first diameter D1.

The cover 800 preferably has a textured surface to reduce slipperiness and is preferably made of a flexible material such as rubber, a flexible thermoplastic, etc., the preferred materials being either low density polyethylene or santoprene, preferably with a conventional UV blocker added (such materials and the means of their fabrication being well known to those in the art).

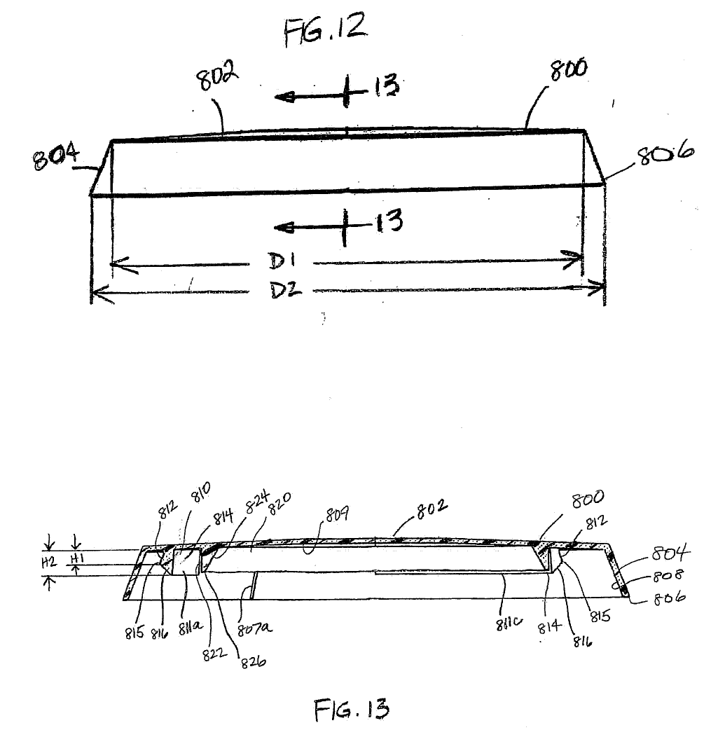

Referring to FIGS. 13-15, a second annular flange 810 extends downwardly from a lower surface 809 of the upper wall 802 and is disposed radially inwardly from the first annular flange 804. The second annular flange 810 is formed by three flange sections 811a-811c that each include an angled side surface 812 and a generally vertical side surface 814, wherein the angled and vertical surfaces 812, 814 have first and second heights H1, H2 (FIG. 13), respectively. Preferably, although not necessarily, the height H1 of the angled surface 812 is less than the height H2 of the vertical surface 814. The angled surface 812 also terminates at a foot or cleat 815 at a bottom portion thereof. The foot or cleat 815 is defined by a tapered surface 816 that extends between the angled and vertical surfaces 812, 814. In the case where the height H1 of the first vertical surface 812 is less than the height H2 of the second vertical surface 814, the tapered surface 816 is diagonally oriented such that the tapered surface 816 slants downwardly from the first vertical surface 812 to the second vertical surface 814.

At least one and preferably three ribs 807a-807c extend radially inwardly, across the inwardly facing surface of the first annular flange 804 and continuing radially inwardly across the lower surface 809 of the cover 800 to a location beyond the radial location of the second annular flange 810. Preferably, one rib 807a-807c is located in each of the spaces between the three flange sections 811a-811c and are spaced about 120 degrees from each other. When the cover 800 is in place on the rim 720 of the container 700, each rib 807a-807c causes the cover to be slightly raised from the rim, forming gaps 826 between the cover and the rim. The gaps 826 form air paths for venting air into and out of the container 700 when the cover 800 is disposed over the container 700 and the device 400.

A third annular flange 820 extends downwardly from the lower surface 809 of the upper wall 802 and is disposed radially inwardly of the second annular flange 810, as further seen in FIGS. 13-15. The third annular flange 820 includes a second generally vertical surface 822 and a diagonal surface 824 extending inwardly from a bottom portion 826 of the third vertical surface 822 to the upper wall 802 of the cover 800 such that the vertical and diagonal surfaces 822, 824 define a generally triangular cross section.

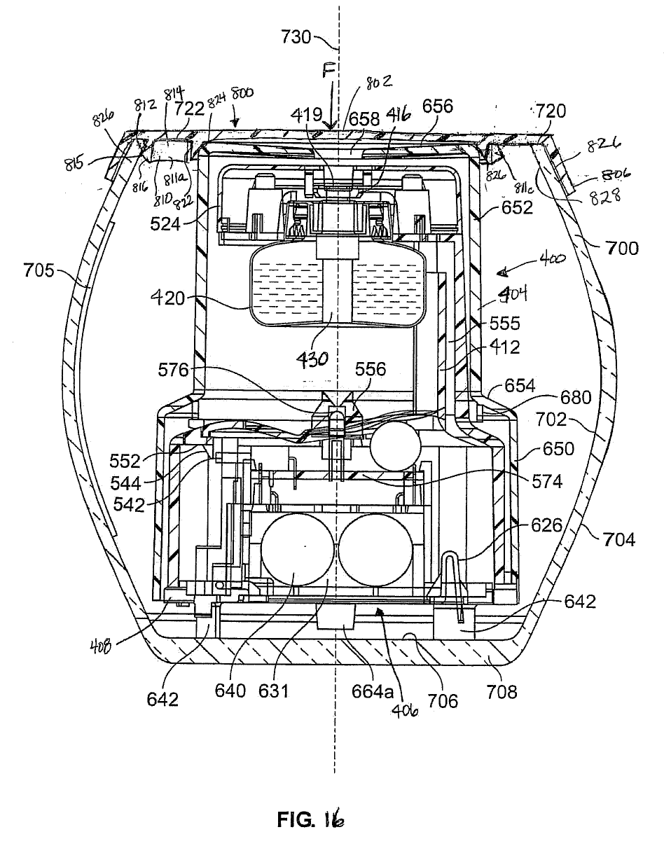

As seen in FIG. 16, the cover 800 is placed atop the container 700 and device 400 such that the first annular flange 804 is disposed adjacent the outer surface 704 of the container 700. The angled side surfaces 812 and the cleats 815 of the flange sections 811a-811c bear resiliently against an inner surface 828 of the container 700 to secure the annular rim 720 of the container 700 between the flange sections 811a-811c and the first annular flange 804. The second annular flange 810 is provided in the form of flange sections 811a-811c to prevent jamming of the second annular flange 810 with respect to the container 700. This discontinuous design accounts for slight variations in the size of the annular rim 720 of the container 700. Further, the diagonal surface 824 of the third annular flange 820 bears against an outer rim 830 of the cover portion 404 of the device 400 to engage and center the cover portion 404 of the device 400. The cover 800 is thereby snugly retained atop the container 700. Thus, if the container 700 and/or device 400 are left outdoors, the first annular flange 804 prevents rain, snow, insects, etc. from entering the container 700 and/or device 400. The angled surfaces 812 and cleats 815 of the flange sections 811a-811c and the first annular flange 804 form a snug fit with the annular rim 720 of the container 700 such that force is necessary to attach and remove the cover 800 from the container 700. In this manner, the cover 800 will not be detached from the container 700 by wind or other natural outdoor conditions.

Still further, a confining fit is created between the diagonal surface 824 and the outer rim 830 of the cover portion 404. This confining fit restricts the device 400 from moving excessively within the container 700 during storage or transportation of the device 400 within the container 700. However, the confining fit is not so tight as to force the cover portion 404 sufficiently downwardly to cause unintended actuation of the device 400. Similarly, the fit is such that, if the cover 800 is positioned back on the container 700 after the device 400 has been used, space between the diagonal surface 824 and the cover portion 404 is sufficient to allow for the escape by evaporation of any volatile material remaining on or above the cover portion.

Although preferably the flanges 804 and 820 are continuous and the flange 810 is discontinuous, as seen in FIGS. 13-17, such flanges may alternatively be continuous, segmented, and/or any number of flanges may be utilized to carry out the functions performed by each of the individual flanges 804, 810, and 820.

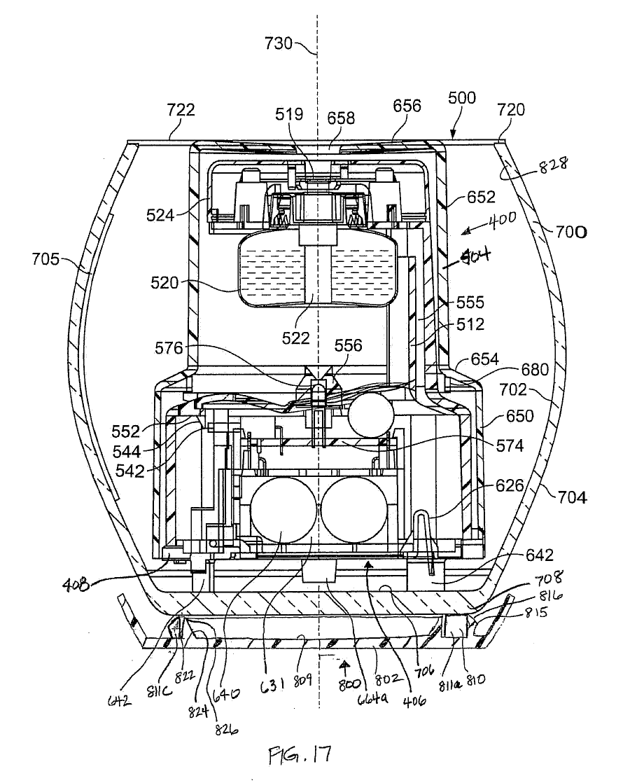

The cover 800 provides a way to turn the device 400 on and off. As seen in FIG. 16, a force F may be exerted downwardly on the cover 800 when the cover 800 is disposed atop the container 700 and the device 400 is disposed within the container 700. Due to the flexible nature of the cover 800, the force F causes the cover 800 to flex downwardly to contact and depress downwardly the cover portion 404 of the device 400. As discussed in detail above, depression of the cover portion 404 moves the cover portion 404 downwardly, thereby causing the spring finger 682 that is aligned with the depressible button 602 to contact the depressible button 602 such that the switch 600 is turned on. Once the switch 600 has been turned on, the cover 800 may thereafter be removed and placed below the bottom portion 708 of the container 700, preferably resting atop both of the second and third annular flanges 810, 820, as seen in FIG. 17. Optionally, the cover 800 may be stored in another manner. Still optionally, a delay may occur after the switch 600 has been turned on and before the atomizer assembly 416 begins dispensing the active material, to allow a user time to remove the cover 800 without active material being dispensed on the cover 800 or elsewhere.

In order to turn the device 400 off, the cover 800 may be retrieved or removed from beneath the bottom portion 708 of the container 700 and placed atop the container 700 in the manner described above with respect to FIGS. 12-15. Thereafter, the force F may again be exerted downwardly on the cover 800 to depress the cover portion 404 of the device 400 downwardly, thereby causing the spring finger 682 to contact the depressible button 602 to turn the switch 600 off. Optionally, a user may simply exert a downward force on the cover portion 404 to turn the switch 600 off. Any volatile material adhering to the cover 800 as a consequence of this procedure is vented from under the cover via the gaps 826 formed by the spaced ribs 807a-807c, promptly leaving the lower surface 809 of the cover 800, which faces the cover portion 404, dry and free of such material.

One method of using the device 400 includes optionally turning the device on by way of the slide switch 583, placing the device 400 within the container 700, attaching the cover 800 to the container 800, and activating the switch 600 by exerting a downward force on a center portion of the cover 800. If the device 400, container 700, and cover 800 are sold assembled, the switch 600 only need be activated for use thereof.

Optionally, the device 400, container 700, and cover 800 may be sold together or separately and, any component may be sold with directions describing the use of one or more of the device 400, container 700, and/or cover 800.

### INDUSTRIAL APPLICABILITY

The light and active material emitting device provides light and/or active material emitters. The device provides an overall desired aesthetic ambience in an area, such as a room or an outdoor area.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. An active material diffuser, including:
a container;
a device for emitting an active material, wherein the device is adapted to be disposed within the container during use of the device; and
a cover disposed atop the container and enclosing the device within the container when the device is not in use.

2. The diffuser of claim 1, wherein the cover is made of a flexible material.

3. The diffuser of claim 1, wherein the active material is an insect control active ingredient.

4. The diffuser of claim 1, wherein the device includes an atomizer assembly for dispensing the active material therefrom, and wherein the rate of delivery of the active material is such that a dwell time between puffs of active material is between about 250 milliseconds and about 500 milliseconds.

5. The diffuser of claim 1, wherein the device also emits light therefrom.

6. The diffuser of claim 1, wherein the cover includes first, second, and third annular flanges extending from a surface thereof.

7. The diffuser of claim 6, wherein the first annular flange is disposed adjacent an outer surface of the container when the cover is disposed atop the container.

8. The diffuser of claim 7, wherein the first annular flange includes at least one spaced rib extending from an inner surface thereof to create an air flow path between the first annular flange and the outer surface of the container.

9. The diffuser of claim 7, wherein the second annular flange is disposed inwardly of the first annular flange and includes three flange sections disposed adjacent an inner surface of the container when the cover is disposed atop the container and wherein the first and second annular flanges create a snug fit with an annular rim of the container to retain the cover on the container.

10. The diffuser of claim 9, wherein the third annular flange is disposed inwardly of the second annular flange and the third annular flange further creates a confining fit with a cover portion of the device when the device is disposed within the container and the cover is disposed atop the container to center and stabilize the device within the container.

11. The diffuser of claim 2, wherein pressure on a center portion of the cover is transferred to the device such that downward movement of the center portion of the cover triggers a switch within the device.

12. An active material diffuser, including:
a container having an opening; and
a device for emitting an active material, wherein the device is disposed within the opening of the container; and
a flexible cover removably attached to the container to close the opening and enclose the device within the container, wherein pressure exerted on a portion of the cover is transferred to the device to actuate the device.

13. The diffuser of claim 12, wherein the cover includes a first annular flange extending therefrom and disposed adjacent an outer surface of the container when the cover is disposed atop the container.

14. The diffuser of claim 13, wherein the cover includes a second annular flange extending therefrom and disposed inwardly of the first annular flange and adjacent an inner surface of the container when the cover is disposed atop the container and wherein the first and second annular flanges create a snug fit with an annular rim of the container to retain the cover on the container.

15. The diffuser of claim 15, wherein the cover includes a third annular flange disposed inwardly of the second annular flange and wherein the third annular flange further creates a confining fit with a cover portion of the device when the device is disposed within the container and the cover is disposed atop the container to center and stabilize the device within the container.

16. A method of providing an active material diffuser, the method comprising the steps of:
providing a container, a device contained within the container for emitting an active material, and a cover for the container; and
directing a user to actuate the device by pressing downwardly on the cover when the device is disposed within the container and the cover is removably attached to the container and then to remove the cover from the container.

17. The method of claim 16, further including the step of placing the cover beneath the container after the device has been actuated.
